(19) United States
(12) Patent Application Publication
(10) Pub. No.: US 2026/0073394 A1
(43) Pub. Date: Mar. 12, 2026

(54) Decentralized Information-Security Processes and Systems for Dynamic, Artificial-Intelligence Centric, Auto-Generative Protection Against Cross-Channel Threat in Multi-Modal Networks

(71) Applicant: Bank of America Corporation, Charlotte, NC (US)

(72) Inventors: Shailendra Singh, Maharashtra (IN); Sneha Padiyar, East Mumbai (IN)

(21) Appl. No.: 18/215,274

(22) Filed: Jun. 28, 2023

(51) Int. Cl. G06Q 20/40; G06N 10/20; G06N 10/60

(52) U.S. Cl. CPC G06Q 20/4016; G06N 10/20; G06N 10/60

(57) ABSTRACT

Decentralized information-security (IS) mitigates against cross-channel threats vectors with a photonic quantum computing machine (PQCM). Threat signals are communicated to consortium members. Live model libraries regarding the threats, characteristics, metadata, model solutions, etc. are in distributed ledgers. PQCM extracts metadata and analyzes permutations to identify configuration(s) with the highest propensity to mitigate the threat. PQCM determines optimized set(s) of the threat-vector mitigation models for the configuration(s). PQCM auto-generates, dynamically by AI/ML based on the optimized set, IS rules for the configuration. Updated threats, threat characteristics, model configurations, IS rules, etc. for the cross-channel threat can be stored in distributed ledger blockchains, shared with consortium members, and deployed to prevent the threat. Nodal consensus algorithms may be used to reach agreement amongst consortium members to independently confirm threat signal validity, best model combinations, highest propensity scores, and proposed dynamically generated IS rules to address the threat.

### TECHNICAL FIELD

The present disclosure relates to access control in the field of information security and, more particularly, to photonic, quantum computing, artificial intelligence systems, methods, and apparatus for preventing unauthorized access to resources of systems or information systems including the manner of identifying and verifying the entity, process, or mechanism requesting access to the resource, based on real-time, decentralized, cross-channel, threat-vector detection in multi-modal networks.

### DESCRIPTION OF THE RELATED ART

In the field of information security, a decentralized network is a network configuration where there are multiple authorities serving as hubs for participants. In the computing world, a decentralized network architecture distributes workloads among several machines instead of relying on a single central server.

Various emerging technologies in the field of decentralized networks can utilize secure distributed ledgers, which challenges centralized systems by empowering individuals with peer-to-peer digital exchanges and removes third parties and traditional, centralized, intermediary institutions from electronic transactions.

These types of decentralized networks can use blockchain technology. A blockchain is a distributed and secured database or ledger. Applications can be used to handle transactions and run the blockchain. In the blockchain, transactions are recorded in blocks and then verified by other users. If these verifiers agree on a transaction, the block is closed and encrypted; another block is created that has information about the previous block within it. The blocks are “chained” together through the information in each proceeding block, giving it the name blockchain. Information in previous blocks cannot be changed without affecting the following blocks, so there is no way to alter a blockchain. This concept, along with other security protocols, provides the secure nature of a blockchain in decentralized networks.

Decentralized networks present security risks to threat vectors and significant ramifications if any such vector is successful. For example, the immutability and irreversibility of transactions can create problems. If users were to send a transaction to the wrong address, it is likely that the user could lose the asset contained within that transaction (unless the receiver chose to voluntarily return the asset). On the contrary, users may have better protection from a traditional centralized intermediary, which can reverse a faulty or fraudulent transaction. This lack of a backstop for mistakes is one reason many are reluctant to engage with this type of decentralized network.

Another risk is the chance of a hack or smart contract exploit within a dApp or decentralized network protocol. Even if a user does not make an errant transaction, there is still the possibility that you could lose their assets via the decentralized network by, for example, a black hat hacker exploiting a vulnerability in a protocol, cross-chain bridge, or some other decentralized network exploit. Noteworthy examples include The DAO hack, the Ronin bridge exploit, and the Wormhole incident.

In current leading-edge decentralized transaction networks, such as DeFi, each institutional entity and system is managing its own threat-vector control/prevention activities and “know how” in isolation. This is ineffective and presents unacceptable security risks because, for example, there is no communication amongst the decentralized members, let alone all members of a consortium or group that identifies the potential detected threat, notifies the others of the threat, allows the others to verify and reach a consensus on the presence and validity of the threat, shares various proposed models to address individual member solutions for various threats by channel or across channels, computationally determine by AI/ML the optimum solution using various threat models known across the consortium, reach an agreement on the optimized solution, generate information-security rules based on the optimized solution, and then deploy the solution so that all members of the consortium benefit, if desired, from the optimized solution to the cross-channel threat vector.

This is especially problematic in multi-modal networks since hacked information obtained from a threat-vector in one channel can be mined and/or utilized in conjunction with hacked information from other channels such as mobile, IVR, Live Chat, online, credit, debit, etc. platforms and/or communication means. The hacked information can be assembled and/or combined from data collected individually or across one or more of them (i.e., “cross channel”), and then can be used to implement an even more dangerous threat-vector that leverages all of the combined information.

Hence, there is a long felt and unsatisfied need to develop a distributed-ledger based threat-vector control apparatus that can operate and orchestrate in a decentralized way, let alone provide real-time mitigation and security, to automatically derive threat-vector control rules, especially for cross-channel threats, for an entire industry or for a consortium of entities or systems.

### SUMMARY OF THE INVENTION

In accordance with one or more arrangements of the non-limiting sample disclosures contained herein, solutions are provided to address one or more of the shortcomings in the field of information security for decentralized networks by, inter alia, (a) utilizing intelligent apparatus processes that leverage photonic quantum computing machines (PQCM) (or other extremely powerful and fast computing machines) and generative artificial intelligence (AI) (augmented by feedback to the PQCM) to auto-generate threat-vector optimized solutions for cross-channel threats even if the solutions are hosted in a distributed manner by different entities in a consortium; (b) understanding and utilizing dynamic, state-of-art, threat-vector models associated with various cross-channels/multi-modal networks, wherein individual solutions for one or more aspects of the cross-channel threat may be hosted or owned by different consortium entities and available to the consortium members in a distributed fashion; (c) identify the best suitable configuration of combinations and/or permutations of such models that have highest propensity to solve or mitigate the cross-channel threat vectors; (d) deriving cross-channel threat-vector rules dynamically at designated periods or interval (preferably in real-time); (e) using signals from identified models to leverage computing generate N number of possible configuration of AI-models (hosted in distributed repository/database) that can be used to generate information-security rules for cross-channel threat vectors; (f) utilizing generative AI (e.g., knowledge graphs, NLP, LSTM, GAN, etc.) to construct cross-channel threat-vector control rules based on selected optimized AI threat-vector model configurations; (g) implementing a real-time, dynamic, cross-channel threat vector rule generation apparatus wherein the decentralized system can derive new information-security rules at frequent intervals based on detected signal feeds from quantum systems or consortium members; (h) aggregating information-security threat-vector rules from distributed-ledger blockchains; (i) achieving consensus from other participants in the decentralized network on the optimum configuration of threat-vector models to counter identified threats and publishing the agreed derived information-security rules via distributed-ledger blockchains; (j) deploying aggregated information-security rules in downstream applications in real-time or at user defined intervals; and/or (k) implementing systems and processing for decentralized identification and detection of threats as well as decentralized remediation and protection of threats.

Sample primary components of the foregoing may include, for example, one or more of model metadata module(s), quantum (or other fast computing) optimization module(s), dynamic rule engine(s), rule deployment module(s), deep learning module(s), and/or distributed ledger blockchains.

Considering the foregoing, the following presents a simplified summary of the present disclosure to provide a basic understanding of various aspects of the disclosure. This summary is not limiting with respect to the exemplary aspects of the inventions described herein and is not an extensive overview of the disclosure. It is not intended to identify key or critical elements of or steps in the disclosure or to delineate the scope of the disclosure. Instead, as would be understood by a personal of ordinary skill in the art, the following summary merely presents some concepts of the disclosure in a simplified form as a prelude to the more detailed description provided below. Moreover, sufficient written descriptions of the inventions are disclosed in the specification throughout this application along with exemplary, non-exhaustive, and non-limiting manners and processes of making and using the inventions, in such full, clear, concise, and exact terms to enable skilled artisans to make and use the inventions without undue experimentation and sets forth the best mode contemplated for carrying out the inventions.

In some arrangements, a decentralized information-security process for preventing cross-channel threats can comprise the steps of, inter alia, detecting, by a photonic quantum computing machine (PQCM) or other suitable powerful fast-processing computer machine, a cross-channel threat vector; communicating, by the PQCM to a consortium of independent nodes, the cross-channel threat vector; generating, by a consensus algorithm amongst the PQCM and the consortium, agreement on the cross-channel threat vector; extracting, by the PQCM from a live model library, metadata for threat-vector mitigation models; analyzing, by the PQCM based on the metadata, permutations of the threat-vector mitigation models to identify a model configuration with a highest propensity to prevent the cross-channel threat vector; selecting, by the PQCM from the live model library, an optimized set of the threat-vector mitigation models corresponding to the model configuration; auto-generating, dynamically by artificial intelligence on the PQCM based on the optimized set, information-security rules for the model configuration; storing, by the PQCM in a distributed ledger blockchain, the information-security rules for the cross-channel threat vector; and/or deploying, by the PQCM, the information-security rules to prevent the cross-channel threat vector.

In some arrangements, a real-time information-security process for preventing cross-channel threats in a decentralized finance (DeFi) multi-modal network can comprise, inter alia, the steps of: receiving, by a computing machine (CM), identification of a cross-channel threat vector for the DeFi multi-modal network; communicating, by the CM to a consortium of independent nodes, the cross-channel threat vector; generating, by a consensus algorithm amongst the CM and the consortium, agreement on the cross-channel threat vector; extracting, by the CM from a live model library for channels including mobile, credit, debit, and online, metadata for threat-vector mitigation models; analyzing, by the CM based on deep learning of the metadata, permutations of the threat-vector mitigation models to identify a model configuration with a highest propensity to prevent the cross-channel threat vector; selecting, by the CM from the live model library, an optimized set of the threat-vector mitigation models corresponding to the model configuration; auto-generating, dynamically by artificial intelligence on the CM based on the optimized set, information-security rules for the model configuration; storing, by the CM in a distributed ledger blockchain, the information-security rules to prevent the cross-channel threat vector; and/or deploying, by the CM, the information-security rules to prevent caused the cross-channel threat vector, whereby threats are prevented in the DeFi multi-modal network.

In some arrangements, real-time information-security system for preventing cross-channel threats can include, inter alia: a threat-vector identification platform for identifying a threat in a DeFi multi-modal network including at least a mobile channel and an online channel; a live model library containing threat-vector models to attempt to prevent the threat, the live model library coupled to the threat-vector identification platform; a PQCM or other powerful fast-processing CM to detect changes in the live model library, extract metadata from the live model library for the threat-vector models, analyze the metadata by deep learning, and compute permutations of the threat-vector models to generate a model configuration with a highest propensity to prevent the threat; a consensus module used by the PQCM or CM to achieve consensus amongst consortium nodes on the model configuration for the model configuration most likely to prevent the threat; a blockchain retrieval module for the PQCM or CM to extract information-security rule sets in a distributed ledger blockchain corresponding to the threat-vector models for the model configuration; a dynamic rule-generation module for the PQCM or CM to dynamically generate threat-vector control rules derived from the rule sets extracted from the distributed ledger blockchain by the blockchain retrieval module; a blockchain storage module for the PQCM or CM to store, in the distributed ledger blockchain, the control rules that were dynamically generated by the dynamic rule-generation module for the model configuration; a blockchain notification module for the PQCM or CM to provide the consortium nodes with access information to access the information-security control rules that were stored in the distributed ledger blockchain; and/or a deployment module for the PQCM or CM to deploy the information-security control rules to payment platforms to prevent the threat in the DeFi multi-modal network.

In some arrangements, a decentralized information-security process can identify, by the PQCM to the consortium, the distributed ledger blockchain containing the information-security rules to prevent the cross-channel threat vector.

In some arrangements, a PQCM or CM in decentralized information-security process can analyze the model permutations to identify the optimum combination of models based on deep learning such as, for example, by use of a knowledge graph model, LSTM neural network model, a generative adversarial network (GAN) model, or other desired deep learning model. The threat and threat vector models, the solutions to those models in a particular channel, the combined cross-channel threat models, and the current optimized solutions to the cross-channel threats may all be available in a distributed fashion such as, for example, in a series of distributed-ledger blockchains.

In some arrangements, one or more various steps or processes disclosed herein can be implemented in whole or in part as computer-executable instructions (or as computer modules or in other computer constructs) stored on computer-readable media. Functionality and steps can be performed on a machine or distributed across a plurality of machines that are in communication with one another.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

FIG. 1 depicts a sample, functional, flow diagram showing sample interactions, steps, functions, and components to identify optimum threat-vector model combinations in accordance with one or more information-security aspects of this disclosure as they relate to mitigating against cross-channel threat vectors in multi-modal networks.

FIG. 2 depicts a sample, functional, flow diagram showing sample interactions, steps, functions, and components to identify optimum threat-vector model combinations and achieve consensus in decentralized networks, that include multiple entities, systems, or organizations, in accordance with one or more information-security aspects of this disclosure as they relate to mitigating against cross-channel threat vectors in multi-modal networks.

FIG. 3 depicts a sample, functional, architectural-block diagram showing sample interactions, steps, functions, and components to identify optimum threat-vector model combinations achieve consensus in decentralized networks, that include multiple entities, systems, or organizations, and deploy optimized and agreed information-security rules, in accordance with one or more information-security aspects of this disclosure as they relate to mitigating against cross-channel threat vectors in multi-modal networks.

FIG. 4 depicts a sample table showing threat-model configuration permutations for identified threats correlated with propensity scores to identify the optimum combination to provide the best “currently known” protection in accordance with one or more information-security aspects of this disclosure as they relate to mitigating against cross-channel threat vectors in multi-modal networks.

FIG. 5 depicts a sample, decentralized, information-security process for preventing cross-channel threats in accordance with one or more information-security aspects of this disclosure.

FIG. 6 depicts a sample, real-time, information-security process for preventing cross-channel threats in a decentralized multi-modal network in accordance with one or more information-security aspects of this disclosure.

### DETAILED DESCRIPTION

In the following description of the various embodiments to accomplish the foregoing, reference is made to the accompanying drawings, which form a part hereof, and in which is shown by way of illustration, various embodiments in which the disclosure may be practiced. It is to be understood that other embodiments may be utilized, and structural and functional modifications may be made. It is noted that various connections between elements are discussed in the following description. It is noted that these connections are general and, unless specified otherwise, may be direct or indirect, wired, or wireless, and that the specification is not intended to be limiting in this respect.

As used throughout this disclosure, any number of computers, machines, or the like can include one or more general-purpose, customized, configured, special-purpose, virtual, physical, and/or network-accessible devices such as: administrative computers, application servers, clients, cloud devices, clusters, compliance watchers, computing devices, computing platforms, controlled computers, controlling computers, desktop computers, distributed systems, enterprise computers, instances, laptop devices, monitors or monitoring systems, nodes, notebook computers, personal computers, portable electronic devices, portals (internal or external), servers, smart devices, streaming servers, tablets, web servers, and/or workstations, which may have one or more application specific integrated circuits (ASICs), microprocessors, cores, executors etc. for executing, accessing, controlling, implementing etc. various software, computer-executable instructions, data, modules, processes, routines, or the like as discussed below.

References to computers, machines, or the like as in the examples above are used interchangeably in this specification and are not considered limiting or exclusive to any type(s) of electrical device(s), or component(s), or the like. Instead, references in this disclosure to computers, machines, or the like are to be interpreted broadly as understood by skilled artisans. Further, as used in this specification, computers, machines, or the like also include all hardware and components typically contained therein such as, for example, ASICs, processors, executors, cores, etc., display(s) and/or input interfaces/devices, network interfaces, communication buses, or the like, and memories or the like, which can include various sectors, locations, structures, or other electrical elements or components, software, computer-executable instructions, data, modules, processes, routines etc. Other specific or general components, machines, or the like are not depicted in the interest of brevity and would be understood readily by a person of skill in the art.

This disclosure specifically includes, within the foregoing, photonic quantum computing machines and other powerful fast-processing computing machines for detecting and providing optimized protection for cross-channel threats such as, for example, fraud and hacking. By cross-channel threats, this could include, by way of non-limiting examples, fraud between a mobile and a card base channel communication, or a mobile and ATM-based channel communication, or a card and online financial communication, etc. Stated differently, a successful attack (partial or complete) on one channel for example at an ATM where a hacker was able to obtain some information such as a card number, security pin, or other information, could be combined with a hack of online information that yielded other information, or could be combined with information mined from previously hacked data that might be available on the dark web, individually and/or collectively which could then be utilized across these various channels to access a mobile or online resource in an attempt to create a fraudulent payment or DeFi transfer to a hacker.

As used throughout this disclosure, software, computer-executable instructions, data, modules, processes, routines, or the like can include one or more: active-learning, algorithms, alarms, alerts, applications, application program interfaces (APIs), artificial intelligence, approvals, asymmetric encryption (including public/private keys), attachments, big data, blockchains, blocks, CRON functionality, daemons, databases, datasets, datastores, DeFi functionality, drivers, data structures, deep learning modules (e.g., knowledge graphs, NLP, LSTM, GAN, etc.), distributed ledgers, distributed-ledger blockchains, dynamic rule engines, emails, extraction functionality, file systems or distributed file systems, firmware, governance rules, graphical user interfaces (GUI or UI), images, instructions, interactions, Java jar files, Java Virtual Machines (JVMs), juggler schedulers and supervisors, load balancers, load functionality, machine learning (supervised, semi-supervised, unsupervised, or natural language processing), metadata, middleware, modules, namespaces, objects, operating systems, optimization modules, platforms, processes, protocols, programs, rejections, routes, routines, rule deployment modules, security, scripts, tables, tools, transactions, transformation functionality, user actions, user interface codes, utilities, web application firewalls (WAFs), web servers, web sites, etc.

The foregoing software, computer-executable instructions, data, modules, processes, routines, or the like can be on tangible computer-readable memory (local, in network-attached storage, be directly and/or indirectly accessible by network, removable, remote, cloud-based, cloud-accessible, etc.), can be stored in volatile or non-volatile memory, and can operate autonomously, on-demand, on a schedule, spontaneously, proactively, and/or reactively, and can be stored together or distributed across computers, machines, or the like (e.g., in a decentralized network that may include a consortium of networks, entities, institutions, etc.) including memory and other components thereof. Some or all the foregoing may additionally and/or alternatively be stored similarly and/or in a distributed manner in the network accessible storage/distributed data/datastores/databases/big data/blockchains/distributed ledger blockchains etc.

As used throughout this disclosure, computer “networks,” topologies, or the like can include one or more local area networks (LANs), wide area networks (WANs), the Internet, clouds, wired networks, wireless networks, digital subscriber line (DSL) networks, frame relay networks, asynchronous transfer mode (ATM) networks, virtual private networks (VPN), or any direct or indirect combinations of the same. They may also have separate interfaces for internal network communications, external network communications, and management communications. Virtual IP addresses (VIPs) may be coupled to each if desired. Networks also include associated equipment and components such as access points, adapters, buses, ethernet adaptors (physical and wireless), firewalls, hubs, modems, routers, and/or switches located inside the network, on its periphery, and/or elsewhere, and software, computer-executable instructions, data, modules, processes, routines, or the like executing on the foregoing. Network(s) may utilize any transport that supports HTTPS or any other type of suitable communication, transmission, and/or other packet-based protocol. Decentralized networks (e.g., DeFi networks), in particular, are included in the foregoing and are protected by the information-security aspects of this disclosure.

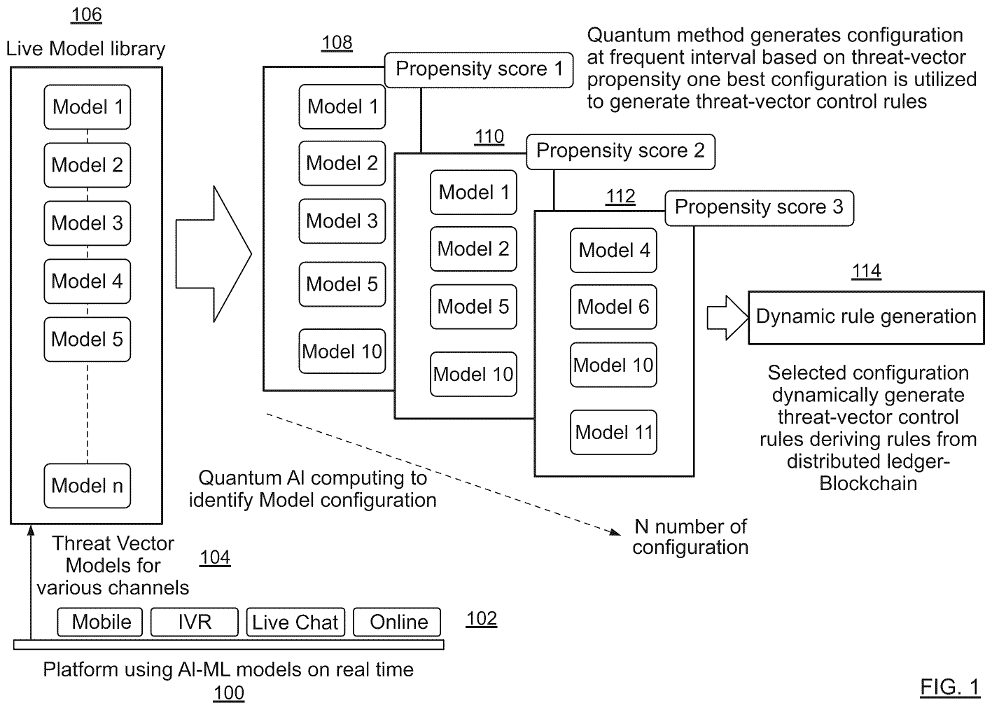

By way of non-limiting disclosure, FIG. 1 depicts a sample, functional, flow diagram showing sample interactions, steps, functions, and components to identify optimum threat-vector model combinations in accordance with one or more information-security aspects of this disclosure as they relate to mitigating against cross-channel threat vectors in decentralized networks.

A platform using AI (including, if desired, various forms of machine learning) 100 is detecting threats and developing threat models for various channels 102 such as, for example, mobile, interactive voice response (IVR), live chat, online, credit, debit, etc. For threats detected by the platform, they can be analyzed by AI on the PQCM or CM to determine whether the threat is a valid signal, identify the characteristics relating to the signal (e.g., it may be a particular threat related to ATMs in a certain geolocation coordinates or have other threat specific characteristics that may be useful to identify and/or categorize it), communicate the threat to other members in a consortium, reach a consensus by the consortium (if desired) that this is a valid threat, etc. Various of the forgoing (e.g., nodal communications, photonic computing, achieving consensus, etc.) is illustrated herein in more detail in similar contexts and could be implemented as noted above for the same reasons in the same way.

As threat vector models for various channels are identified 104, they can be stored in a live model library 106 (e.g., as Model 1, Model 2, Model 3, Model 4, Model 5, . . . Model N, etc.). The threats, their characteristics, the channel(s) in which they have been detected or in which they may be exploited, potential solutions, etc. can be stored as part of the live model library 106 in distributed ledger blockchains or another suitable distributed storage mechanism.

As threats are identified or added to the live model library 106, the PQCM can extract metadata for each model and create a series of permutations 108, 110, 112 of the models and can then calculate a propensity score using artificial intelligence to determine which configuration of models is most likely to be able to mitigate against the threat. As shown in FIG. 1, permutation 108 might include a proposed solution the combines Model 1, Model 2, Model 3, Model 5, and Model 10, and generates Propensity Score 1 for the combination that indicates the likelihood of success against mitigation of the cross-channel threat. Similarly, permutation 110 might include an alternate proposed solution that combines Model 1, Model 2, Model 5, and Model 10 to yield Propensity Score 2. And permutation 112 might combine Model 4, Model 6,Model 10, and Model 11 to generate another Propensity Score 3. Ideally, the PQCM would perform quantum AI computing (in an extremely thorough and fast manner due to the nature of photonic quantum computing) on all possible N combinations to provide a complete mapping of all possible permutations and their likelihood of success.

Various propensity scoring methods and approaches can be utilized. For example, the propensity score could be the probability of using one of the solution models for a threat vector being compared, given the measured covariates. Covariates are the variables included in the threat-vector analysis and AI processing that are not the outcome or the exposure of interest. The propensity score could be calculated by fitting a logistic regression model with threat-vector solution model received as the dependent variable. A logistic regression model measures the change in likelihood of a specific dependent variable given a set of independent variables. This technique can be performed using any currently available statistical software package. The estimated propensity score provides one score for each model and summarizes the information about all the threat-vector variables of interest.

The model combination with the highest propensity score could then be selected as the optimized solution and shared with other consortium members to reach a consensus that this particular solution is optimum. The PQCM could then utilize the information-security rules for each model in the selected combination configuration in order to dynamically generate customized rules for the cross-channel threat vector.

The new information-security rules could be stored in a distributed ledger blockchain, fed back into the live model library, and shared with the other consortium members. The new rules could then also be deployed to various entities, resources, systems, etc. (e.g., payment platforms) in order to provide prompt protection (preferably in real time) against the identified threat vector. As new signals, new models, new information-security rules, etc. are identified or updated, the distributed ledger blockchains can be updated and outdated materials can be disregarded.

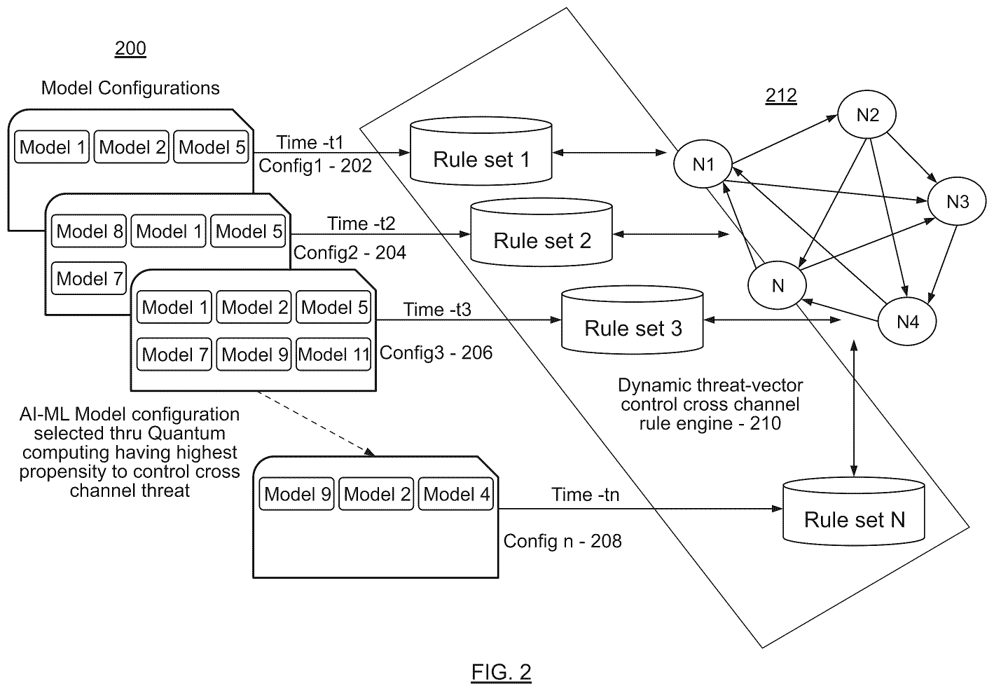

By way of non-limiting disclosure, FIG. 2 depicts a sample, functional, flow diagram showing sample interactions, steps, functions, and components to identify optimum threat-vector model combinations and achieve consensus in decentralized networks, that include multiple entities, systems, or organizations, in accordance with one or more information-security aspects of this disclosure as they relate to mitigating against cross-channel threat vectors in multi-modal networks.

Various model configurations have been identified in 200 at different time intervals such as Models 1/2/5 in Config1 202 at Time=t1 based on certain signal, Models 8/1/5/7 in Config2 204 at a later time of Time=t2 based on a different signal or a modified signal, Models 1/2/5/7/9/11 in Config3 206 at Time=t3 on yet another signal or a further modified signal, and so on for N permutations and some future time of Time=tn in which ConfigN 208 comprises Models 9/2/4. The bottom line is that different model configurations can be assembled and utilized as threats evolve or change. Each can then be input into a dynamic, threat-vector control, cross-channel rule engine 210 that can generate rule data for each selected model in the configuration to dynamically create a rule set corresponding to the configuration that incorporates the rules from each individual selected model in the configuration. Each rule set (e.g., Rule Set 1, Rule Set 2, Rule Set 3, . . . Rule Set N) can then be proposed to nodes 212 in the consortium.

A consensus algorithm can be used to reach agreement on the proposed threat signals (e.g., whether they are valid or not), which models and/or configurations are the best to address the threat, which models and/or configurations have the highest propensity scores, etc. Any type of consensus algorithm can be used. Samples include: Proof of Work (PoW), Proof of Stake (PoS), Practical Byzantine Fault Tolerance (PBFT), Delegated Proof of Stake (DPOS), Proof of Importance (Pol), Ripple Protocol Consensus Algorithm (RPCA), Stellar Consensus Protocol, and Byzantine algorithm. Alternatively, simple voting agreements may be used where consensus is achieved based on the number of votes received by the nodes. Another variation is where some node members in the consortium have a higher weighted value assigned to their votes as opposed to other members of the consortium. One or more of threat detection, model proposals, model updates, model configurations, rule set creations, nodal consensus, etc. may be performed, individually and/or collectively, at frequent intervals, on-demand, or in real-time.

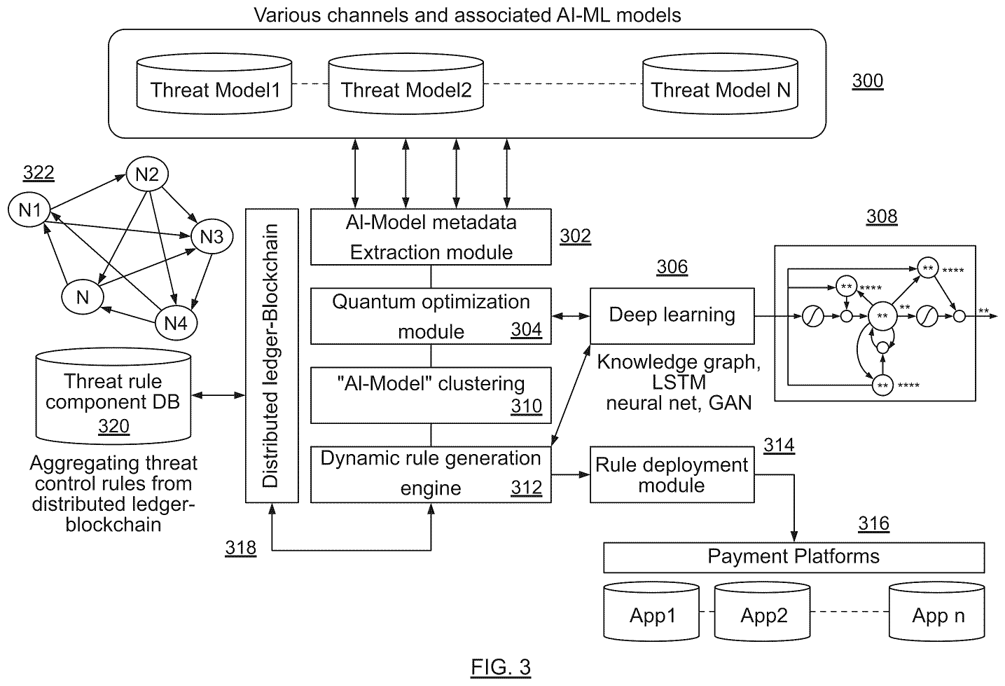

By way of non-limiting disclosure, FIG. 3 depicts a sample, functional, architectural-block diagram showing sample interactions, steps, functions, and components to identify optimum threat-vector model combinations achieve consensus in decentralized networks, that include multiple entities, systems, or organizations, and deploy optimized and agreed information-security rules, in accordance with one or more information-security aspects of this disclosure as they relate to mitigating against cross-channel threat vectors in multi-modal networks.

In 300, a number of threat models (e.g., Threat Model1, Threat Model2, . . . Threat ModeIN) have been detected in various channels and analyzed using associated AI and/or ML models. These can be stored in a blockchain or other suitable storage structures or media. An AI-Model metadata extraction module 302 will extract metadata from one or more of the threat models as needed in order to gather information about the particular threat-vector to be analyzed. Various types of metadata may be extracted and utilized such as: information about what that model is doing, how accurate that model is, what is the purpose of that model, how authentic that particular model is, which consortium and/or non-consortium members are using that model, the reliability and success rate of the model once a threat is detected, etc.

The PQCM uses a quantum optimization module 304 (or in the context of a CM, a non-quantum optimization module) is used to perform cross-channel signal detection validation and/or identify, if signal validity is confirmed, which models to select and utilize in a proposed configuration solution to address the threat-vector.

A deep learning module 306 can be operatively coupled to and in communication with the optimization module 304. The deep learning module can utilize deep learning algorithms in order to understand more precisely what the model is doing, what the design of the model is, what is the purpose of the model, observing anomalies over periods of time, how the model and/or model configurations are responding over periods of time, whether the models and/or model configurations have been invalid, whether the models and/or model configurations are still working, whether cross-channel threats are still being detected correctly by the models and/or model configurations, etc. A sample representation of one generic type of the deep learning analysis is represented in 308 for reference purposes.

AI-Model clustering 310 is operatively coupled to the optimization module 304 and is utilized to cluster models into proposed configuration groups based on their likelihood of successfully addressing threats. Clustering data can include the rules in each model, the threat characteristics, the model metadata, or other suitable data for AI analysis.

Based on the identified configurations during clustering 310 and the insight obtained from deep learning 306, a dynamic rule generation engine 312 can take the rule information in each existing model that was selected to be part of the configuration of models to address the threat vector and then generate a combination set of rules or optimized set of rules that are customized to deal with the particular cross-channel threat. These can be provided to the consortium for nodal consensus on the proposed approach to deal with the threat if desired. A rule deployment module 314 for can then deploy the rules to applicable downstream devices, systems, platforms, apps, etc. in order to execute the rules and prevent/mitigate against the cross-channel threat vectors. In one example, such a platform on which the customized rules for the threat vector could be employed could be payment platforms for the transfer of funds from one entity to another entity or to a potential hacker or other person for a fraudulent or unauthorized transfer. This could be in a channel such as mobile apps like App1, App2, . . . AppN. Perhaps the rule would limit transactions to a certain threshold amount in certain situations fitting similar to the threat vector and would require that a different channel or additional verification be utilized in order to ensure that the proposed transaction is not fraudulent or a threat.

By way of non-limiting disclosure, FIG. 4 depicts a sample table showing threat-model configuration permutations for identified threats correlated with propensity scores to identify the optimum combination to provide the best “currently known” protection in accordance with one or more information-security aspects of this disclosure as they relate to mitigating against cross-channel threat vectors in multi-modal networks.

A mapping table 400 correlates various channels and cross-channels in 402 and the corresponding threat and cross channel threat models in 404. Permutations of each model can be illustrated in 406 to show sample, various, possible combinations for N-models. Each model may have a configuration name or indicia as in 408. A propensity score, based on AI/ML analysis and optimization by the PQCM/CM, is generated in 410 and the best candidate can be selected based on the configuration with the highest score, which, in this example, is Configuration 13 that includes Model Nos.—10. For brevity purposes, every single permutation is not shown in the table. This is only presented for illustrative purposes. Due to the number of models that may need to be evaluated, the number of channels for the threats, the variable number of models that may be needed in a particular configuration to attempt to combat a cross-channel threat, the extensive metadata and threat characteristics, it should be self-evident to a POSITA that a PQCM or ultrapowerful/ultrafast CM is necessary to process all possible model combinations, generate propensity scores, dynamically generate rules etc. due to all of the variables and AI/ML processing required.

By way of non-limiting disclosure, FIG. 5 depicts a sample, decentralized, information-security process for preventing cross-channel threats in accordance with one or more information-security aspects of this disclosure.

A real-time information-security process for preventing cross-channel threats in a decentralized finance (DeFi) multi-modal network is shown. Upon system/process initiation or commencement 500, a PQCM (or suitably powerful/ultrafast CM) can detect a cross-channel threat vector or receive notification of a threat signal, which can be independently verified as well as confirmed by consortium members in 502. The PQCM/CM can notify 504 a consortium of independent nodes of the cross-channel threat vector (as well as provide threat-related information) for their own independent signal validity confirmation if desired. A consensus algorithm 506 may be utilized by the PQCM/CM in conjunction with the computing systems of other nodes in the consortium can be used to verify the threat signal. The PQCM/CM can extract 508 a live model library for channels including mobile, credit, debit, online, etc. metadata for threat-vector mitigation models and analyze 510 based on deep learning of the metadata, permutations of the threat-vector mitigation models to identify a model configuration with a highest propensity to prevent the cross-channel threat vector. The PQCM/CM can select 512, from the live model library, an optimized set of the threat-vector mitigation models corresponding to the optimum model configuration. The PQCM/CM can auto-generate, dynamically by artificial intelligence (and/or ML) 514 on the PQCM based on the optimized set, information-security rules for the model configuration. The PQCM/CM can store, in a distributed ledger blockchain, the information-security rules to prevent the cross-channel threat vector. The information-security rules can be deployed to systems, etc. (e.g., payment platforms) to prevent the cross-channel threat vector, whereby threats are prevented in the DeFi multi-modal network. Nodal consensus algorithms may be used to reach agreement amongst consortium members to independently confirm threat signal validity, best model combinations, highest propensity scores, and proposed dynamically generated information-security rules to address the threat. The process may continue indefinitely in real time or at on-demand intervals as desired 520, or otherwise terminate 522 if preferred.

The decentralized information-security process can identify, by the PQCM to the consortium, the distributed ledger blockchain containing the information-security rules to prevent the cross-channel threat vector.

The PQCM or CM in the decentralized information-security process can analyze the model permutations to identify the optimum combination of models based on deep learning such as, for example, by use of a knowledge graph model, LSTM neural network model, a generative adversarial network (GAN) model, or other desired deep learning model. The threat and threat vector models, the solutions to those models in a particular channel, the combined cross-channel threat models, and the current optimized solutions to the cross-channel threats may all be available in a distributed fashion such as, for example, in a series of distributed-ledger blockchains.

By way of non-limiting disclosure, FIG. 6 depicts a sample, real-time, information-security process for preventing cross-channel threats in a decentralized multi-modal network in accordance with one or more information-security aspects of this disclosure.

A real-time information-security process 600 for preventing cross-channel threats in a decentralized finance (DeFi) multi-modal network can comprise, inter alia, the steps of: receiving, by a high-capacity ultrafast computing machine (CM) (or PQCM), identification of a cross-channel threat vector for the DeFi multi-modal network 602; communicating, by the CM to a consortium of independent nodes, the cross-channel threat vector 604; generating, by a consensus algorithm amongst the CM and the consortium, agreement on the cross-channel threat vector 606; extracting, by the CM from a live model library for channels including mobile, credit, debit, online, etc., metadata for threat-vector mitigation models 608; analyzing, by the CM based on deep learning of the metadata, permutations of the threat-vector mitigation models to identify a model configuration with a highest propensity to prevent the cross-channel threat vector 610; selecting, by the CM from the live model library, an optimized set of the threat-vector mitigation models corresponding to the model configuration 612; auto-generating, dynamically by artificial intelligence on the CM based on the optimized set, information-security rules for the model configuration 614; storing, by the CM in a distributed ledger blockchain, the information-security rules to prevent the cross-channel threat vector 616; and/or deploying, by the CM, the information-security rules to prevent caused the cross-channel threat vector 618, whereby threats are prevented in the DeFi multi-modal network. The process may continue 620 or terminate 622 as desired.

Although not separately shown for redundancy and brevity purposes, a real-time information-security system for preventing cross-channel threats can include, inter alia: a threat-vector identification platform for identifying a threat in a DeFi multi-modal network including at least a mobile channel and an online channel; a live model library containing threat-vector models to attempt to prevent the threat, the live model library coupled to the threat-vector identification platform; a PQCM or other powerful fast-processing CM to detect changes in the live model library, extract metadata from the live model library for the threat-vector models, analyze the metadata by deep learning, and compute permutations of the threat-vector models to generate a model configuration with a highest propensity to prevent the threat; a consensus module used by the PQCM or CM to achieve consensus amongst consortium nodes on the model configuration for the model configuration most likely to prevent the threat; a blockchain retrieval module for the PQCM or CM to extract information-security rule sets in a distributed ledger blockchain corresponding to the threat-vector models for the model configuration; a dynamic rule-generation module for the PQCM or CM to dynamically generate threat-vector control rules derived from the rule sets extracted from the distributed ledger blockchain by the blockchain retrieval module; a blockchain storage module for the PQCM or CM to store, in the distributed ledger blockchain, the control rules that were dynamically generated by the dynamic rule-generation module for the model configuration; a blockchain notification module for the PQCM or CM to provide the consortium nodes with access information to access the information-security control rules that were stored in the distributed ledger blockchain; and/or a deployment module for the PQCM or CM to deploy the information-security control rules to payment platforms to prevent the threat in the DeFi multi-modal network.

As noted above, a decentralized information-security process can identify, by the PQCM to the consortium, the distributed ledger blockchain containing the information-security rules to prevent the cross-channel threat vector.

Also as noted above, a PQCM or CM in decentralized information-security process can analyze the model permutations to identify the optimum combination of models based on deep learning such as, for example, by use of a knowledge graph model, LSTM neural network model, a generative adversarial network (GAN) model, or other desired deep learning model. The threat and threat vector models, the solutions to those models in a particular channel, the combined cross-channel threat models, and the current optimized solutions to the cross-channel threats may all be available in a distributed fashion such as, for example, in a series of distributed-ledger blockchains.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A decentralized information-security process for preventing cross-channel threats comprising the steps of:
detecting, by a photonic quantum computing machine (PQCM), a cross-channel threat vector;
communicating, by the PQCM to a consortium of independent nodes, the cross-channel threat vector;
generating, by a consensus algorithm amongst the PQCM and the consortium, agreement on the cross-channel threat vector;
extracting, by the PQCM from a live model library, metadata for threat-vector mitigation models;
analyzing, by the PQCM based on the metadata, permutations of the threat-vector mitigation models to identify a model configuration with a highest propensity to prevent the cross-channel threat vector;
selecting, by the PQCM from the live model library, an optimized set of the threat-vector mitigation models corresponding to the model configuration;
auto-generating, dynamically by artificial intelligence on the PQCM based on the optimized set, information-security rules for the model configuration;
storing, by the PQCM in a distributed ledger blockchain, the information-security rules for the cross-channel threat vector; and
deploying, by the PQCM, the information-security rules to prevent the cross-channel threat vector.

2. The decentralized information-security process of claim 1 further comprising the step of identifying, by the PQCM to the consortium, the distributed ledger blockchain containing the information-security rules to prevent the cross-channel threat vector.

3. The decentralized information-security process of claim 2 wherein the permutations are analyzed by the PQCM using deep learning.

4. The decentralized information-security process of claim 3 wherein the deep learning is based on a knowledge graph model.

5. The decentralized information-security process of claim 3 wherein the deep learning is based on an LSTM neural net model.

6. The decentralized information-security process of claim 3 wherein the deep learning is based on a generative adversarial network (GAN) model.

7. The decentralized information-security process of claim 4 wherein the live model library includes fraud models for channels including mobile, credit, debit, and online.

8. The decentralized information-security process of claim 7 wherein the information-security rules are deployed in real-time to prevent fraud in a decentralized finance (DeFi) network.

9. The decentralized information-security process of claim 7 wherein said steps of communicating, extracting, analyzing, selecting, auto-generating, storing, and deploying are performed in real-time, after said detecting of the cross-channel threat vector by the PQCM, to prevent fraud in a decentralized finance (DeFi) network.

10. The decentralized information-security process of claim 8 wherein the information-security rules are deployed to payment platforms.

11. The decentralized information-security process of claim 9 wherein the information-security rules are deployed to payment platforms.

12. A real-time information-security process for preventing cross-channel threats in a decentralized finance (DeFi) multi-modal network comprising the steps of:
receiving, by a computing machine (CM), identification of a cross-channel threat vector for the DeFi multi-modal network;
communicating, by the CM to a consortium of independent nodes, the cross-channel threat vector;
generating, by a consensus algorithm amongst the CM and the consortium, agreement on the cross-channel threat vector;
extracting, by the CM from a live model library for channels including mobile, credit, debit, and online, metadata for threat-vector mitigation models;
analyzing, by the CM based on deep learning of the metadata, permutations of the threat-vector mitigation models to identify a model configuration with a highest propensity to prevent the cross-channel threat vector;
selecting, by the CM from the live model library, an optimized set of the threat-vector mitigation models corresponding to the model configuration;
auto-generating, dynamically by artificial intelligence on the CM based on the optimized set, information-security rules for the model configuration;
storing, by the CM in a distributed ledger blockchain, the information-security rules to prevent the cross-channel threat vector; and
deploying, by the CM, the information-security rules to prevent caused the cross-channel threat vector, whereby fraud is prevented in the DeFi multi-modal network.

13. The real-time information-security process of claim 12 wherein the information-security rules are deployed to payment platforms.

14. The real-time information-security process of claim 13 further comprising the step of providing, by the CM to the consortium, access information in order to access the distributed ledger blockchain containing the information-security rules to prevent the cross-channel threat vector.

15. The real-time information-security process of claim 14 wherein the deep learning is based on a knowledge graph model.

16. The real-time information-security process of claim 14 wherein the deep learning is based on an LSTM neural net model.

17. The real-time information-security process of claim 14 wherein the deep learning is based on a generative adversarial network (GAN) model.

18. The real-time information-security process of claim 14 wherein the CM is a photonic quantum computing machine.

19. The real-time information-security process of claim 18 wherein the photonic quantum computing machine analyzes all possible permutations of the threat-vector mitigation models to identify the model configuration with the highest propensity to prevent the cross-channel threat vector.

20. A real-time information-security system for preventing cross-channel threats comprising:
a threat-vector identification platform for identifying a fraud threat in a decentralized finance (DeFi) multi-modal network including at least a mobile channel and an online channel;
a live model library containing threat-vector models to attempt to prevent the fraud threat, said live model library coupled to the threat-vector identification platform;
a photonic quantum computing machine (PQCM) to detect changes in the live model library, extract metadata from the live model library for the threat-vector models, analyze the metadata by deep learning, and compute permutations of the threat-vector models to generate a model configuration with a highest propensity to prevent the fraud threat;
a consensus module used by the PQCM to achieve consensus amongst consortium nodes on the model configuration for the model configuration most likely to prevent the fraud threat;
a blockchain retrieval module for the PQCM to extract rule sets in a distributed ledger blockchain corresponding to the threat-vector models for the model configuration;
a dynamic rule-generation module for the PQCM to dynamically generate fraud control rules derived from the rule sets extracted from the distributed ledger blockchain by the blockchain retrieval module;
a blockchain storage module for the PQCM to store, in the distributed ledger blockchain, the fraud control rules that were dynamically generated by the dynamic rule-generation module for the model configuration;
a blockchain notification module for the PQCM to provide the consortium nodes with access information to access the fraud control rules that were stored in the distributed ledger blockchain; and
a deployment module for the PQCM to deploy the fraud control rules to payment platforms to prevent the fraud threat in the DeFi multi-modal network.
